(19) United States
(12) Patent Application Publication
(10) Pub. No.: US 2003/0214883 A1
(43) Pub. Date: Nov. 20, 2003

(54) Setting structure module for timer

(75) Inventor: Albert Stekelenburg, Taipei (TW)

Correspondence Address: BRUCE H. TOXELL, SUITE 1404, 5205 LEESBURG PIKE, FALLS CHURCH, VA, 22041, US

(73) Assignee: All-Time Inc.

(21) Appl. No.: 10/145,026

(22) Filed: May 15, 2002

(51) Int. Cl. G04F 8/00; G04F 10/00

(52) U.S. Cl. 368/107

(57) ABSTRACT

A Setting structure module for timer, which comprising a hollow but can be opened and closed top housing and a bottom housing, a time setting apparatus which positioned in upper portion of the top housing; upon the middle of upper ply plate inserting a middle cover which through the inner hole of time setting apparatus; The left side inner the bottom housing provides an synchronize electric, their power supply connecting apparatus and the gear transmission system which connecting to the output axle of synchronize electric; In the right side inner the lower ply plate provide switch dial and micro switch

### FILED OF THE INVENTION

The present invention is relating to a timer, especially to the timer movement which having an upper plate and a lower plate.

### BACKGROUND OF THE INVENTION

The time setting apparatus of current mechanical timer usually divided into two Types. The first one is inserting a pin to the pre-opened ON-OFF holes and the second type is by moving the switch dial which usually located outside the timer plate horizontally or vertically. The disadvantage of the first type are using 30 minutes but not available in 15 minutes as an unit and the pin are easily lost. Furthermore, the time setting is limited to the number of pins. The disadvantage of the second type is because the switch dial located outside the timer, it is easily broken by outside force and the position may be changed accidentally which arise the error operation. Furthermore, the dimension is larger and the structure always in more complicated.

The current mechanical timer provides no operation indication and whether the timer is in operation depends on voice or long time observation.

The current mechanical timer is not able to adjust the time difference caused by the difference of micro switch. Therefore, the precise of time is about 15 minutes plus minus 5%.

The power supply connecting apparatus of current mechanical timer using synchronize electricity, usually by printing circuit board, the voltage decrease resistance is more difficult to install and the reliability is poor.

### SUMMARY OF THE INVENTION

The purpose of the present invention is providing a timer movement which overcome the above-mentioned disadvantage and enable more convenient operation for timer, having operation indicating dial, synchronize electricity connecting apparatus and précising time adjust apparatus.

In order to achieve the purpose, the alternative adapted by the present invention is a timer movement, which including a hollow but openable top housing 12 and a bottom housing 13, a time setting apparatus 50 which positioned in upper portion of the top housing 12; upon the middle of upper ply plate inserting a middle cover 9 which through the inner hole of time setting apparatus 50; The left side inner the bottom housing 13 provides an synchronize electric 16, their power supply connecting apparatus and the gear transmission system which connecting to the output axle of synchronize electric. In the right side inner the lower ply plate 13 provide switch dial 14 and micro switch 1, characterized in:

Said time setting apparatus is in round pan shape, including a setting pin base 23 which mounted with the outer surface of central extruding of top housing 12 and turning around the outside circumference. On the top portion of setting pin base provides a dissociable dial ring 7, between the outer edge of setting pin base 23 and dialing ring 23 provides 96 setting pins 11 which can slide along the axle direction. The upper surface of said middle cover 9 provides operation indicating needle 10, the lower portion of said operation indicating needle is cylindrical sleeve, which inserting into the upper portion of first grade transmission 17 of said gear transmission mission and through the upper wall of middle cover 9. The top of operation indicating needle is in the same height of the middle cover 9. The power supply connecting apparatus of said electric fixed in one side of inner chamber of bottom housing 13, which comprising A electric conducting plate 2, B electric conducting plate 3 and C electric conducting plate 6 and D electric conducting plate 7 which extending from the outer wall of bottom housing 13. Meanwhile, between A electric conducting plate 2 and D electric conducting plate 7, and B electric conducting plate 3 and C electric conducting plate 6, welded with A electric resistance 5 and B electric resistance 4.

The lower cylindrical rod of said turnable setting pin base provides the last grade connecting gear 30 of gear transmission system which can mesh transmission gear 21, the turning speed is 24 hours per turn. The extending plate of setting pin base 23 provides 4 holes 31, the outer edge provides 96 positioning groove 32 and under the outer circumference having protrude 33.

Under said dialing ring 8 vertically layout 4 small vertical protrude 34 which corresponding to said 4 holes 31 of setting pin base 23. Said 4 small vertical protrude 34 inserting said four hole 31 of setting pin base 23 to form the connection between dialing ring 8 and setting pin base 23; The upper outer circumference of dial ring 8 printed with 24 hour time indicia 35, the lower outer circumference provide 89 passage groove 36 which corresponding to the 96 positioning groove 32 and extending downwardly to form 96 shallow groove 37.

Said setting pin includes: the open groove 38 which provided in the middle portion of setting pin 11 and slideable in the outer circumference of setting pin base 23; the upper portion of setting pin 11 vertically provides a moving head 39 which through the passage groove 36 and appear the upper surface. The end portion of setting pin 11 provides tail 40, its shape corresponding to the shallow groove 37 of dial ring 8, the sides of tail could get touch with the touching rod 41 which provided vertically from said switch dial 14.

The switch dial 14 further provides time setting precise adjustment apparatus. Said apparatus includes a micro switch interval switch dial adjust slide 43 which mounted and slideable in the upper section of switch dial 14, its inner side which touch with micro switch touching head 42 is sloping plane; the end of outer side provides the jaw 44 which mesh with the teeth of upper portion of switch dial 14.

By the way, because of the time setting apparatus composed by setting pin base, dial ring and setting pin, the setting pin can slide between in the rail between the setting pin base and dial ring, timely pushing switch dial to connect the micro switch, therefore, the time setting apparatus is more reliable and more convenience in operation. Because there is operation indicating needle provided, it can be easily seen whether it is working; because there is a micro switch interval switch dial adjust slide, therefore the error or time difference can be effectively adjusted. The precise will be promoted to 16 minutes plus and minus 1 minute, the setting error less than 1 minute. Because of the power supply connecting apparatus composed by 4 electric conducting plates and two electric resistances and fixed in one side of bottom housing, therefore, the power supply connection is more simple and reliable.

### BRIEF DESCRIPTION OF DRAWINGS

FIG. 1 is the view of overall structure of the timer movement.

FIG. 2 is the top view of the timer movement.

FIG. 3 is the plain view of removing the top housing and locating the transmission system, switch dial and micro switch as well as interval adjustment apparatus.

FIG. 4 is the plain view of removing the top housing and locating the power supply connecting apparatus of synchronize electric and micro switch.

FIG. 5 is the longitude sectional view of setting pin base of the time setting apparatus.

FIG. 6 is the longitude sectional view of dial ring of the time setting apparatus.

FIG. 7 is the main view of the setting pin of the time setting apparatus.

### DESCRIPTION OF THE PREFERRED EMBODIMENT

The detail of the present invention is disclosed hereunder by combining the drawings.

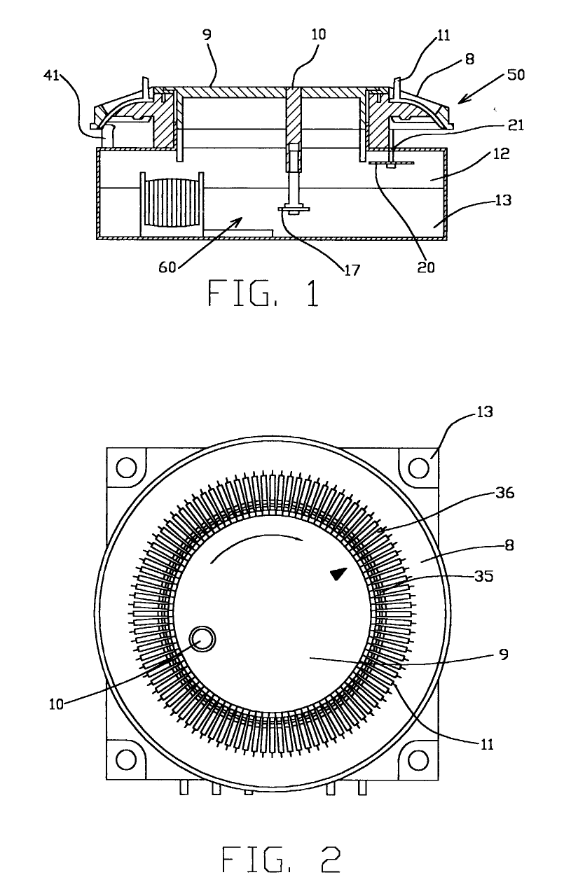

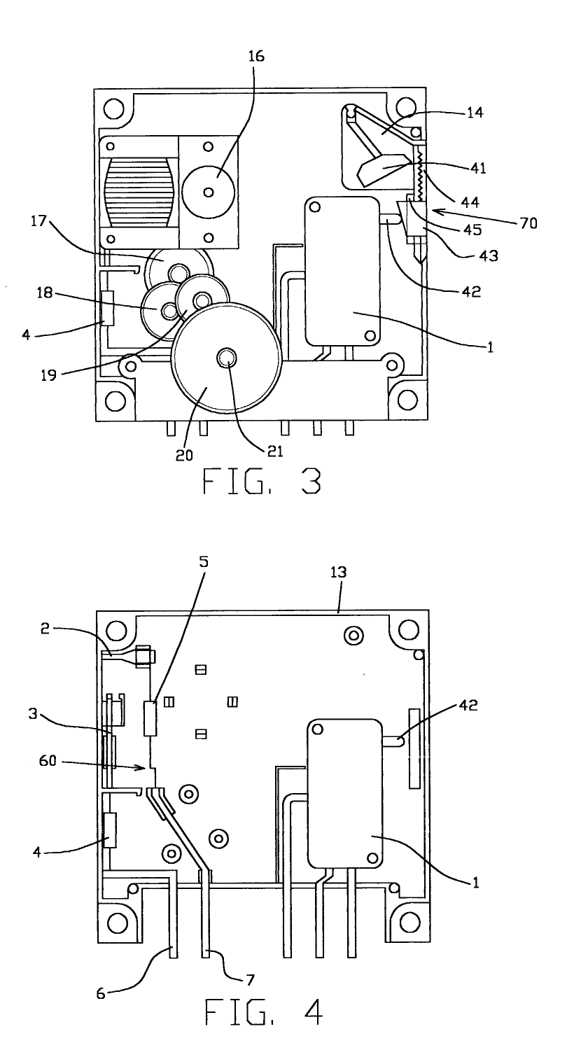

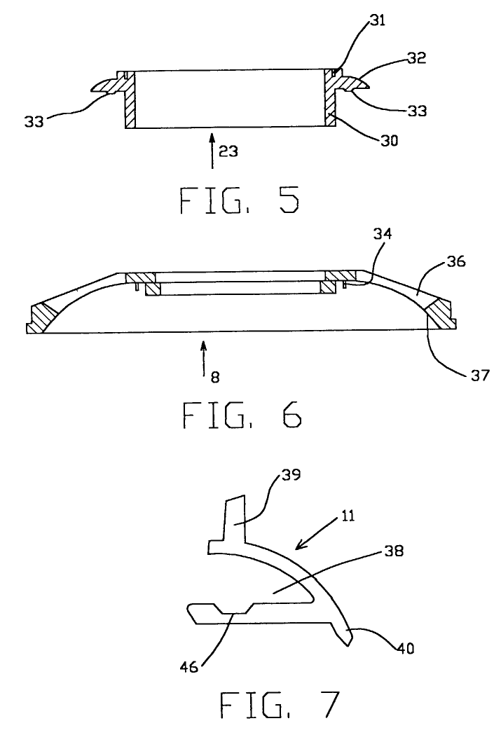

As shown in FIGS. 1 to 7, the movement of the present invention including a hollow but can be opened or closed top housing 12 and bottom housing 13, an time setting apparatus 50 which located in the upper portion of top housing 12, a middle cover 9 mounted and connected in the middle portion of top housing 12; said middle cover 9 extrude through the inner hole of time setting apparatus 50 and its top plane is the top surface of the movement of the present invention. In the left side inner the bottom housing, provides a synchronize electric 16 and its power supply connecting apparatus, as well as the gear transmission system which connected with the output axle of synchronize electric. In the left side within bottom housing 13 providing the switch dial 14 and micro switch 1. Characterized in that said time setting apparatus is in round pan shape, including a setting pin base 23 which mounted with the outer surface of central extruding of top housing 12 and turning along the outside circumference. The lower portion of pin base 23 is in cylindrical shape with the last connecting gear 30 for gear transmission system; Said connecting gear 30 meshed with transmission gear 21, the speed is 24 hours per circle. The upper part of pin base 23 provides a n extruding plane which having four holes 31, the top of the pin base 23 provides 96 positioning grove 32 which operate as guide rail, and the lower portion circumference providing the protrude 33; On the upper portion of pin base 23, providing the dissociable dial ring 8 which downwardly extending four small vertical protrude 34 ( Refer to FIG. 6) which corresponding to the four holes 31 by inserting the small protrude 34 into the four holes 31, the pin base 23 is connecting with dial ring 8. On the top circumference of dial ring 8, printing with 24 hours time indicia 35, the lower outer circumference of dial ring 8, printing with 96 passage groove 36 which corresponding to the 96 positioning grove 32. Extending outwardly from the lower surface of passage groove 36, provides 96 shallow groove 37. Between the circumferences of pin base 23 and dial ring 8, there are 96 setting pins 11, which can independently slide along the longitude rail, that means, said pin base 23 and dial ring 8 are fully counterpart and slide in the groove which composed by the upper and lower rail. The grove has certain depth and contacting with setting pin 11 side by side, except positioning but also preventing the shaking of setting pin 11. The middle part of setting pin 11 provides open groove 38 which can be mounted with pin base 23 and slideable thereon. The top surface of open grove 38 slide along the positioning grove 32 of pin base 23, the bottom surface of open grove provides groove 46 which match with the protrude 33 of setting pin base 23 which enable the setting pin 11 producing the flexibility and stability during the operation. The upper part of setting pin 11 vertically extending a moving head 39 which pass through the passage groove 36 and appear its upper surface. The moving head 39 can be moved by hand and slide along longitude direction. In the end of setting pin 11 provides a tail 40 and its shape of upper surface corresponding to the said shallow groove 37 of dial ring 8 and available for mutual slide. When moving the moving head 39 by hand, its sideway y touch the touching rod 41 which upwardly extending from the switch dial 14 to achieve the purpose of time setting. The middle cover 9 of top housing 12 pass through the inner holes of time setting pin base 23 and dial ring 8 and the top plane e is the top surface of movement of this timer. The top plane of middle cover 9 provides the operation indicating needle 10 and its lower portion is cylindrical sleeve which can be mounted to the first transmission gear 17 of said gear transmission system and further pass through and with the same height of middle cover 9. Said synchronize power supply connecting apparatus is fixed in one side of inner chamber of bottom housing 13 (refer to FIG. 1) which including the A conducting plate 2, B conducting plate 3, and C conducting 6 and D conducting plate 7 which extending from bottom housing 13. These conducting plate are connected with said synchronize power supply connecting apparatus 60. Furthermore, between A conducting plate A and D conducting plate 7; and B conducting plate 3 and C conducting plate 6, there are welded with A electrical resistance 5 and B electrical resistance 4, thereby composed a complete synchronize power supply. Beside, there is a time setting precise adjust apparatus 70 (refer to FIG. 3) provided in said switch dial 14, said switch dial 70 including a micro switch interval switch dial adjust slide 43 which mounted and slideable in switch dial 14. The inner side which contact with micro switch touching head 42 is slopping plane and the end of outside provides the jaw 44 which meshed with the teeth in upper section of switch dial 14 to prevent slide automatically. In order to achieve the purpose of adjust the switch dial adjust slide 43, on the bottom side of bottom housing 13 provided a pass hole 45 which corresponding to switch dial adjust slide 43. Through the pass hole, the switch dial adjust slide can be moved. Because the travel interval of micro switch always inconsistently, the present invention is not using the way of operate switch dial 14 directly with micro switch but through the switch dial adjust slide 43 to adjust the position. In practice, the slopping plane of micro switch dial adjust slide 43 contacting with switch touching head 42, the height of contact changing and thereby remedy the interval inconsistence and hence improve the precise of time setting to plus minus 1 minute.

When practicing, locating the timer movement to the timer is in working condition. Firstly, move the setting pin 11 outwardly, because every pin is 15 minutes, therefore, by the number of moving pin to obtain the setting time. This number can be the initial for power supply of turning speed 30 r.p.m of synchronize electric 16. Once the synchronize electric 16 obtain the power supply, the output axle bring the first grade gear and the transmission ration is 30, then second grade gear 18, third grade gear 19, fourth grade gear 40, and gear 21 meshed with the last gear 30 of setting pin base 23 which enable the timer apparatus 50 turning. The outwardly moved and time set tail 40 of setting pin pushing the touching rod 41 of switch dial 14, and through the micro switch dial adjust slide 43 of switch dial 14 pushing the touching head 42 of micro switch and make the connection, to achieve cut off the circuit in preset time interval. Because the transmission ration of first grade is 30, the turning speed of gear 17 is 1 r.p.m., and the turning speed of the operation indicating needle 10 which mounted on the upwardly extending axle of gear 17 alsi 1 r.p.m., which is the turning speed of second dial, therefore whether the timer operate can be viewed directly.

While the foregoing description shows only preferred embodiments of the invention, various modifications and alterations of the present invention will be apparent to those skilled in the art without departing from the scope of the invention which is defined by the appended claims. Therefore, the embodiments shown and described are only illustrative, not restrictive.

1. A Setting structure module for timer, which comprising a hollow but can be opened and closed top housing 12 and a bottom housing 13, a time setting apparatus 50 which positioned in upper portion of the top housing 12; upon the middle of upper ply plate inserting a middle cover 9 which through the inner hole of time setting apparatus 50; the left side inner the bottom housing 13 provides an synchronize electric 16, their power supply connecting apparatus and the gear transmission system which connecting to the output axle of synchronize electric; in the right side inner the lower ply plate 13 provide switch dial 14 and micro switch 1, characterized in:
said time setting apparatus is in round pan shape, including a setting pin base 23 which mounted with the outer surface of central extruding of top housing 12 and turning around the outside circumference; on the top portion of setting pin base provides a dissociable dial ring 7, between the outer edge of setting pin base 23 and dialing ring 23 provides plurality of setting pins 11 which can slide along the axle direction; the upper surface of said middle cover 9 provides operation indicating needle 10, the lower portion of said operation indicating needle is cylindrical sleeve, which inserting into the upper portion of first grade transmission 17 of said gear transmission mission and through the upper wall of middle cover 9; the top of operation indicating needle is in the same height of the middle cover 9; the power supply connecting apparatus of said electric fixed in one side of inner chamber of bottom housing 13, which comprising A electric conducting plate 2, B electric conducting plate 3 and C electric conducting plate 6 and D electric conducting plate 7 which extending from the outer wall of bottom housing 13; meanwhile, between A electric conducting plate 2 and D electric conducting plate 7, and B electric conducting plate 3 and C electric conducting plate 6, welded with A electric resistance 5 and B electric resistance 4.

2. The setting structure module for timer as claimed in claim 1, characterized in said lower cylindrical rod of said turnable setting pin base provides the last grade connecting gear 30 of gear transmission system which can mesh transmission gear 21, the turning speed can be 24 hours or a week per turn; The extending plate of setting pin base 23 provides 4 holes 31, the outer edge provides plurality of positioning groove 32 and under the outer circumference having protrude 33.

3. The setting structure module for timer as claimed in claim 1, characterized in that under said dialing ring 8 vertically layout 4 small vertical protrude 34 which corresponding to said 4 holes 31 of setting pin base 23; Said 4 small vertical protrude 34 inserting said four holes 31 of setting pin base 23 to form the connection between dialing ring 8 and setting pin base 23; The upper outer circumference of dial ring 8 printed with 24 hour time indicia 35, the lower outer circumference provide plurality of passage groove 36 which corresponding to the positioning groove 32 and extending downwardly to form shallow groove 37.

4. The setting structure module for timer as claimed in claim 1, characterized in said setting pin includes: the open groove 38 which provided in the middle portion of setting pin 11 and slideable in the outer circumference of setting pin base 23; the upper portion of setting pin 11 vertically provides a moving head 39 which through the passage groove 36 and appear the upper surface; The end portion of setting pin 11 provides tail 40, its shape corresponding to the shallow groove 37 of dial ring 8, the sides of tail could get touch with the touching rod 41 which provided vertically from said switch dial 14.

5. The setting structure module for timer as claimed in claim 1, characterized in said switch dial 14 further provides time setting precise adjustment apparatus; Said apparatus includes a micro switch interval switch dial adjust slide 43 which mounted and slideable in the upper section of switch dial 14, its inner side which touch with micro switch touching head 42 is sloping plane; the end of outer side provides the jaw 44 which mesh with the teeth of upper portion of switch dial 14.

6. The setting structure module for timer as claimed in claim 1, characterized in said the bottom surface of bottom 13 providing a passage hole which corresponding to micro switch travel interval switch dial adjust slide.

7. The setting structure module for timer as claimed in claim 1, characterized in the turning speed of synchronize electric is 30 r.p.m., the transmission ratio of the first grade gear is 30; the turning speed of operation indicating needle which mounted in the upward extending axle of first transmission gear is 1 r.p.m..
